(19) United States
(12) Patent Application Publication
(10) Pub. No.: US 2007/0229706 A1
(43) Pub. Date: Oct. 4, 2007

(54) INFORMATION READING APPARATUS

(76) Inventors: Junichiro Watanabe, London (GB); Yukinobu Maruyama, Kokubunji (JP); Yujin Tsukada, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/673,079

(22) Filed: Feb. 9, 2007

(30) Foreign Application Priority Data
Mar. 28, 2006 (JP) JP 2006-086861

(51) Int. Cl. H04N 5/46

(52) U.S. Cl. 348/555; 348/E05.114

(57) ABSTRACT

As the number of contents which a user can access (TV programs, images stored on HDD or Internet news) is increasing, the contents a viewer wishes to view is becoming increasingly diverse, and consequently the question of how to view these contents efficiently is now a major problem. In other words, this huge volume of broadcast content also contains information which the user does not require, and it is difficult to efficiently acquire only the required information without any error. To resolve this problem, there are therefore provided an information reading apparatus comprising a receiving means which receives first and second broadcast signals, an information reading means which displays and reads the first broadcast signal received by the receiving means as first image information, a storage means which stores the second image information contained in the second broadcast signal, and an extraction means which extracts a part of the second image information stored by the storage means, wherein the information display means displays a part of the image in the second image information extracted by the extraction means superimposed on the image of the first image information, and reads it.

### CLAIM OF PRIORITY

The present application claims priority from Japanese application JP 2006-086861 filed on Mar. 28, 2006, the content of which is hereby incorporated by reference into this application.

### FIELD OF THE INVENTION

The present invention relates to a method of viewing broadcast and communication information.

### BACKGROUND OF THE INVENTION

In recent years, broadband network infrastructures which can perform high speed data communications are becoming more common. For example, high-speed data communication services for the home using optical fibers are becoming more widespread, and permit users to acquire information from the Internet without concern about communication speed.

At the same time, TV broadcasts are becoming more diversified, and there are various types of broadcast such as terrestrial digital broadcasting, satellite broadcasting, and cable TV broadcast. In addition, thanks to the telecom infrastructure mentioned above, it is now possible to distribute TV program content using the Internet, and various broadcast services are therefore emerging. For example, on-demand video delivery through the Internet (Video On-Demand), and television broadcasting (IPTV) using Internet Protocol, etc. are becoming increasingly common. As a result, a user can now access his favorite TV program content interactively using bidirectional broadband communications, and users are thus enjoying more freedom of choice in TV broadcasting. By using these telecom infrastructures, a broadcasting company can distribute a large number of broadcasts (for example, 100 or more channels) at once, so the number of broadcasts which a user can view is continually increasing. As part of this technology, there is a technique for distributing only text information in a video signal as another signal and a technique which can extract only text information, so it is also possible to acquire only text information as well as the usual image-only information (JP-A No. 2001-111910).

Recorders with a hard disk for recording a TV program (hereafter, HDD recorders), or personal computers (hereafter, PC) having plural TV tuners, are now quite common. The capacity of the hard disk with which these devices are provided is also increasing every year, and in recent years has increased to the order of terabytes (TB). There are many products fitted with several TV tuners, and the number of TV tuners installed in them is also tending to increase.

Standards are also emerging for interconnecting domestic TV, HDD recorders and PC in a home network, and by interconnecting the devices, it is possible to view various stored contents from any of these home devices.

In such a situation, it may occur that the total domestic HDD capacity is of terabyte order, and since there may be several or many TV tuners, the number of TV programs, music, images and other information which a user can access domestically is increasing, and a user can freely choose which program to view from a plethora of choices.

### SUMMARY OF THE INVENTION

However, since the content which a user wants to view is becoming increasingly varied due to the increased content (TV programs, video stored on HDD or Internet news), the question of how to efficiently select this content is now a difficult issue. In other words, the huge amount of broadcast content also contains a large amount of information which the user does not need, so the problem is how to view the required information efficiently and without making a mistake.

For example, in order to view plural TV programs broadcast simultaneously, one method might be to view one program at the current time (on air) while simultaneously recording the other program for later viewing, or to view plural TV programs by frequently changing the channel. However, the former method is unsuitable for programs which attach importance to real time events such as sports programs or news, and with the latter method, the user may miss the scenes he wishes to view in the programs.

As a means to solve this problem, TV footage may be split into plural child screens, and plural programs displayed on these child screens. If this method is used, the user can view plural TV programs simultaneously.

However, with this method, since the full screen information contained in each TV program is displayed, it is hard to notice a screen change within a certain program, and there is still the problem that the user may miss a particular scene in the program.

The present invention was conceived to resolve this problem.

In the prior art, for example, when viewing a music program, news and a baseball relay broadcast simultaneously, it was difficult, while watching mainly the music program, for the user to focus his attention on the news program only when a topic in which he was interested came on, or to focus his attention on the baseball program only when the match points changed.

It is therefore an object of the invention, which was conceived to solve this problem, to provide a method of displaying only required information within a program, in order to simultaneously view plural TV programs efficiently.

Specifically, it provides a method of specifically displaying some screens which show required information among plural TV programs superimposed on other TV program screens. It provides a method for detecting a variation in program details, and determining the size and position of part of the screen dynamically. It further provides, regarding the signal broadcast by the broadcasting station, a method of efficiently viewing plural broadcast contents and acquiring required information by embedding information for displaying a part of the screen.

To achieve the aforesaid object, the method of the present invention has a means to display partial screens of TV programs which are live or recorded, superimposed on other TV programs which are live or recorded, or superimposed on an Internet browser screen. For example, when viewing a music program, a baseball relay broadcast, and a news program simultaneously, it has a means to display the program on the whole screen, and to display only part of the baseball program showing the match points, and only the telop (text information) of the news program, superimposed thereupon.

The invention has a means to dynamically adjust the position and size of part of the screen according to a variation of the audio and video amounts in the program. Hence, it can enlarge the size of the part showing the points in the baseball match whenever the points change, or enlarge a scene dealing with a topic in the news by detecting a particular keyword related thereto uttered by an announcer during the news program. Hence, the user does not miss a particular scene he wishes to view even when plural programs are viewed simultaneously.

The invention provides a method of not only selecting and pasting part of the screen described above on the TV program receiving side, but also of embedding information for capturing part of the screen in the signal from the program broadcast side. By containing information such as the position coordinates of the screen capture part, the size of this part, and the capture start and end time in the broadcast signal, part of a second screen can be easily superimposed on the first screen without the user performing a capture operation.

The invention further provides a method of embedding links to related information such as the program provider or sponsor in the broadcast signal, and thereby permits a screen displaying, for example, the sponsor's Internet site superimposed on the broadcast program.

The invention resolves these problems by means of the following information reading apparatus:

(1) An information reading apparatus comprising a receiving means which receives first and second broadcast signals, an information reading means which displays and reads the first broadcast signal received by the receiving means as first image information, a storage means which stores the second image information contained in the second broadcast signal, and an extraction means which extracts part of the second image information stored by the storage means, wherein the information display means displays part of the image in the second image information extracted by the extraction means superimposed on the image of the first image information, and reads it.
(2) An information reading apparatus comprising a receiving means which receives first and second broadcast signals, and an information reading means which displays and reads the first broadcast signal received by the receiving means as first image information, wherein the second broadcast signal has second image information and position information in the whole display area of the information reading means of the second image information, and a storage means which stores the second image information and position information, and superimposes the image in the second image information at a position in the whole display area of the position information stored by the storage means on the image in the first image information, and reads it.

The invention makes it possible to efficiently acquire information from plural broadcast contents. Due to the invention, plural types of variegated information can be efficiently accessed by simultaneously reading a time digest (e.g., an exciting scene or a scene related to a keyword previously registered by the user), and reading a spatial digest (part of the screen).

### BRIEF DESCRIPTION OF THE DRAWINGS

FIG. 1 is a diagram showing the system configuration according to the invention;

FIG. 2 is a diagram showing a typical screen according to the invention;

FIG. 3 is a diagram showing an example of a screen change accompanying a screen cutout operation according to the invention;

FIG. 4 is a diagram showing a screen cutout operation sequence according to the invention;

FIG. 5 is a diagram showing a screen cutout method according to the invention;

FIG. 6 is a diagram showing screen cutout information according to the invention;

FIG. 7 is a diagram showing the operation sequence when a cutout area is selected by dragging a pointer according to the invention;

FIG. 8 is a diagram showing an example where a screen is cut out using a cutout pattern according to the invention;

FIG. 9 is a diagram showing screen cut out information according to the invention;

FIG. 10 is a diagram showing the operation sequence when a cutout area is selected using a predefined cutout pattern according to the invention;

FIG. 11 is a diagram showing an example of screen cutout by a free cursor remote control operation according to the invention;

FIG. 12 is a diagram showing the operation sequence when a cutout area is selected by a free cursor remote controller according to the invention;

FIG. 13 is a diagram showing an example where the size of the screen on which the cutout of the invention is displayed superimposed, is changed according to the invention;

FIG. 14 is a diagram showing the operation sequence where the screen size is changed by recognizing a pre-registered keyword according to the invention;

FIG. 15 is a diagram showing an example where the screen is displayed by varying the transmittancy of the screen according to the invention;

FIG. 16 is a diagram showing an example where the screen size is changed and repositioned according to the invention;

FIG. 17 is a diagram showing an example of a method for disposing part of a cutout screen according to the invention;

FIG. 18 is a diagram showing an example of a method for disposing part of a cutout screen according to the invention;

FIG. 19 is a diagram showing an example where screen cutout information is inserted into a broadcast signal according to the invention;

FIG. 20 is a diagram showing an example where “human” and “telop” information is contained in a broadcast signal according to the invention;

FIG. 21 is a diagram showing a production method when a cutout image is superimposed according to the invention;

FIG. 22 is a diagram showing an example of a method for linking to a server or a sponsor according to the invention;

FIG. 23 is a diagram showing an example where image cutout information is shared between various terminals according to the invention;

FIG. 24 is a diagram showing an example where a cutout image is selected by a cursor and read according to the invention; and

FIG. 25 is a diagram showing an example of a method for hiding part of a screen according to the invention.

### DETAILED DESCRIPTION OF THE PREFERRED EMBODIMENTS

Hereafter, some embodiments of the invention will be described referring to the drawings. Here, the operating device is taken to be a TV, it may be another device as long as it is a device which reproduces information.

Here, a TV broadcast is described as an example, but in addition to a TV broadcast, it may be content distributed via the Internet, text information provided at a Web site, etc., or an image taken by a digital camcorder.

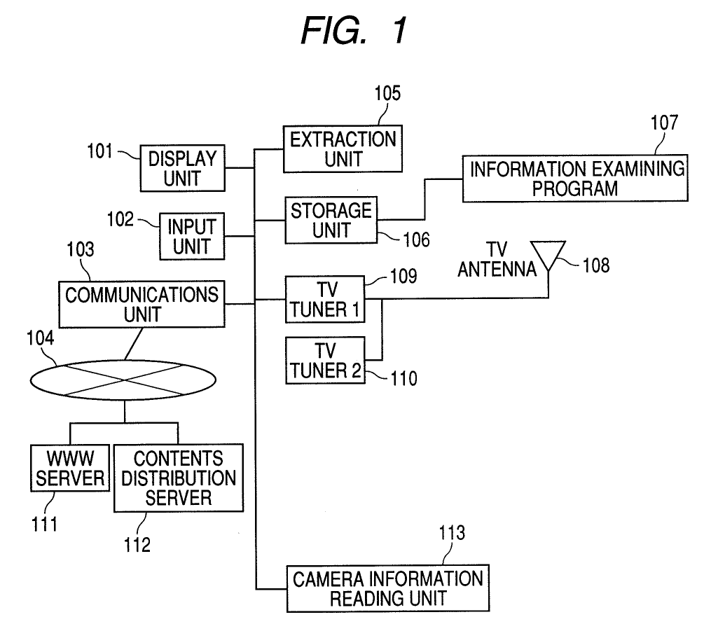

FIG. 1 is a schematic diagram showing one embodiment of the invention.

101 is a display unit for displaying contents, 102 is an input part for inputting an operating signal, 103 is a communications unit for acquiring EPG (Electronic Program Guide) information, image contents and information on a Web site, etc. via the Internet, 104 is the Internet, 105 is an extraction part (computing unit) which performs screen cutout processing, 106 is a storage unit for recording recorded contents, 107 is an information viewing program which searches content stored in a storage unit and displays it on a display area, 108 is a TV antenna, 109, 110 are tuners for receiving a TV signal, 111 is a WWW server which distributes Web information, 112 is a content distribution server which distributes image content, and 113 is a camera information reading unit for acquiring camera video information, such as a digital camcorder or a surveillance camera.

In the information display device of the invention, plural program contents are received using plural television tuners. In FIG. 1, the TV antenna is connected with two TV tuners 109,110 and two channels are received simultaneously, but if there are plural television tuners, there may be more than or less than two.

In the basic layout of the invention, the television tuners 109-110 receive TV images, a storage unit 160 stores the received images and EPG, a computing unit 105 searches data selected from image data stored in the storage unit, and a viewing program 107 for viewing the searched image data and EPG.

This basic layout may be incorporated in an existing device which has a display (display unit 101), such as a TV or personal computer, image data and Web sites may be displayed on this display, and the display unit 101 may be an external device.

Also, instead of a TV tuner, a camera system such as a surveillance camera which performs regular surveillance may be connected, and content acquired from a camera information reading part 113 may be received. Instead of a TV program or a surveillance camera image, streaming image content data may be received from a content distribution server 112 which distributes image content.

The information viewing program 107 is stored in the storage unit 106, and when the extraction unit 105 starts the information viewing program 107, image data of a TV program acquired via the TV tuner or the Internet, or content accumulated in the storage unit, a camera image inputted from a camera information reading unit, or information provided by the web server 111 acquired via the Internet from the communications unit or provided by the contents distribution server 112, is displayed on a screen.

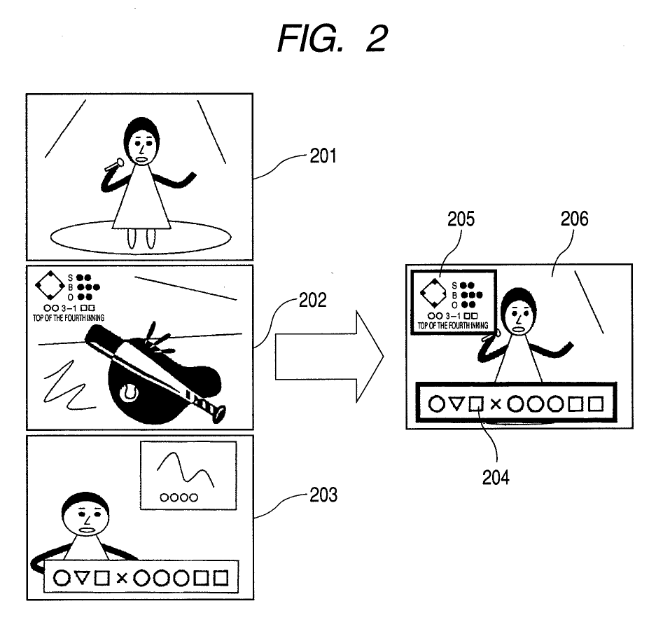

In the diagram, the screen cutout processing of the screen will now be described. First, a TV signal 1 is received using a tuner 1109, and displayed on the display unit 101. The result will look like, for example, a screen display 201 in FIG. 2.

Next, a TV signal 2 is received using a tuner 2110, and displayed on the display unit 102. The result will look like, for example, a screen display 202 in FIG. 2. Here, using any of the methods described later, the extraction unit 105 selects and cuts out a desired part from the screen 202. Time information, screen position and the recorded TV signal for performing cutout processing, are stored by the storage unit 106.

Finally, after terminating screen cutout processing in the extraction part 105, part of the screen of the TV signal received by the tuner 2102 is displayed superimposed on the screen of the TV signal received by the tuner 1101.

The result will look like, for example, a screen display 206 in FIG. 2.

Here, an example was described where two TV signals were received using tuner 1 and tuner 2, and a cutout was displayed superimposed on another image, but a third TV signal may be received using a third tuner, part of the third TV footage cut out, and displayed on the first and second TV screens.

Instead of receiving a TV signal using a tuner, video information provided by a WWW server 111 or information on the Internet received via the Internet 104 or communications unit 103, may be arbitrarily cut out by the extraction unit 105, and displayed superimposed.

Alternatively, instead of receiving a TV signal using a tuner, cutout processing may be performed by the extraction unit 105, and video information inputted by the camera information reading part 113 may be displayed superimposed on a TV signal screen.

FIG. 2 shows an example of the information display method in the invention.

This example shows the case of viewing a music program 201, baseball relay broadcast 202, and news program 203 simultaneously.

In this example, the music program 201 is displayed full screen, the news program 203 displays a telop (204), and the baseball relay broadcast program 202 displays match points, which are respectively superimposed on each other (206). As this example shows, the user can simultaneously acquire only the information he requires such as the text of the news program and match points in the baseball broadcast while mainly viewing the music program.

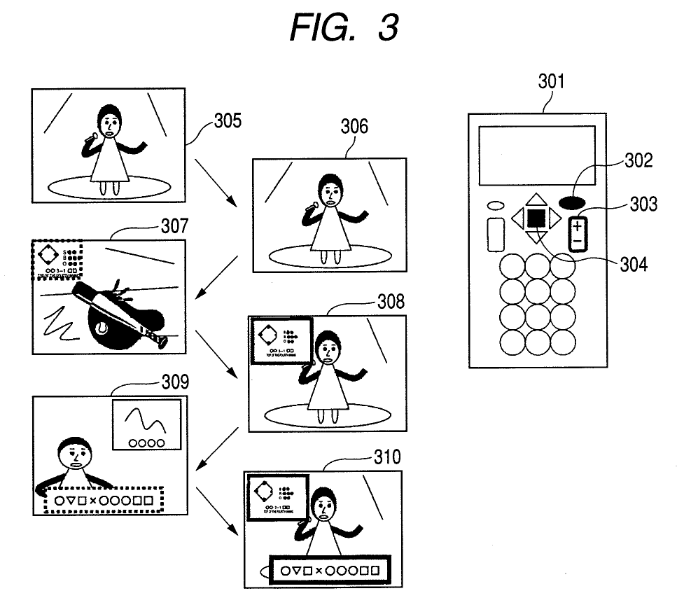

FIG. 3 shows an example of the operation method in the case of displaying plural TV programs superimposed on each other according to the invention.

In the diagram, 301 is a remote controller, this controller being provided with a screen selection button 302, channel change button 303, and determining button 304. In the diagram, 305, 306, 307, 308, 309, 310 show the appearance of the screen in a time series.

In the diagram, first, the channel change button 303 of the remote controller 301 is operated to select a program it is desired to view (305). At this stage, the screen is displayed full screen.

In the diagram 305, when the selection button 302 of the screen is pressed, the program is registered in the storage unit 105 as a main program. On the main program, parts of other programs are displayed superimposed. At this stage, the same screen as 305 is displayed (306), but other programs are not yet superimposed thereupon.

Next, in the diagram, the channel is changed, another program is displayed and a specific area in the program is specified (307). The method of specifying a specific area will be described later. In the diagram, at the stage 307, when the determining button 304 of the remote controller is pressed, the area specified by 307 is displayed superimposed on the main program (308). In the diagram, another program is selected in the same way, and after specifying a specific area in this program 309, the determining button of the remote controller is pressed, and this area is displayed superimposed on the main program (310).

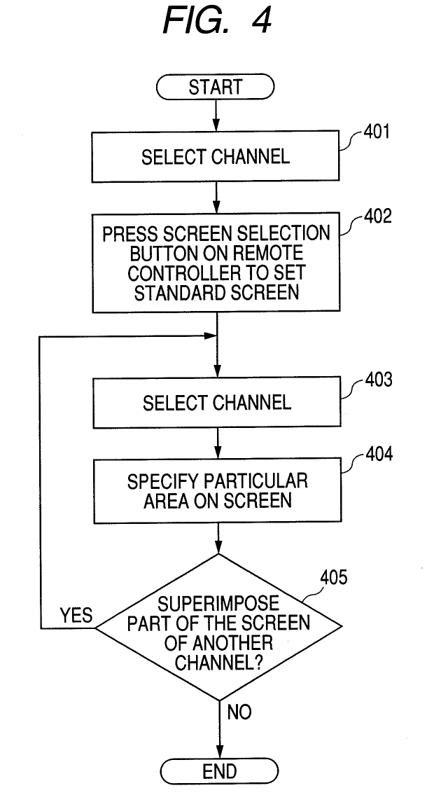

FIG. 4 is a flow chart for describing the sequence of steps in the example shown in FIG. 3. In the diagram, first, the channel is changed and a program which it desired to make the main program, is searched (401). Next, the selection button 302 of the remote controller screen is pressed, and the selected program is set as the main program (402). In the diagram, next, the channel is changed to search another program to display superimposed on the main program (403). A specific area in the screen of the program currently displayed is selected, the determining button is pushed, and the area is displayed superimposed on the main program (404). In the diagram, if it is further desired to display part of another program superimposed on the main program, parts of plural programs can be displayed superimposed on the main program by repeating the steps 405, 403 and 404.

FIGS. 3 and 4 described how to setup a standard screen and select parts of some screens by a remote control button operation, but these operations may be performed using another method such as a keyboard or a mouse.

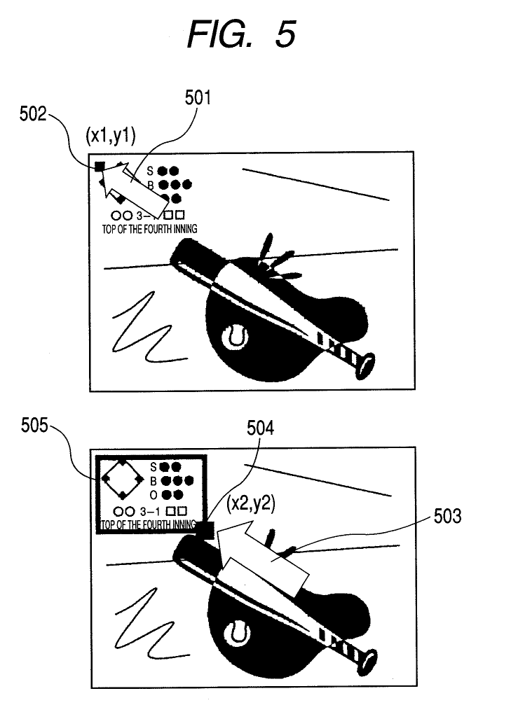

FIG. 5 shows an example, according to the invention, of a method where the user cuts out part of a screen. In this example, the user first selects a program for which part of the screen is to be cut out. Then, pointers 501,503 such as a mouse of a personal computer or a free cursor remote control, are dragged from upper left coordinates (x1, y1) 502 to lower right coordinates (x2, y2) 504 of the part to be cut out. Thus, a square area 505 dragged with the pointer is cut out, and displayed superimposed on the standard screen.

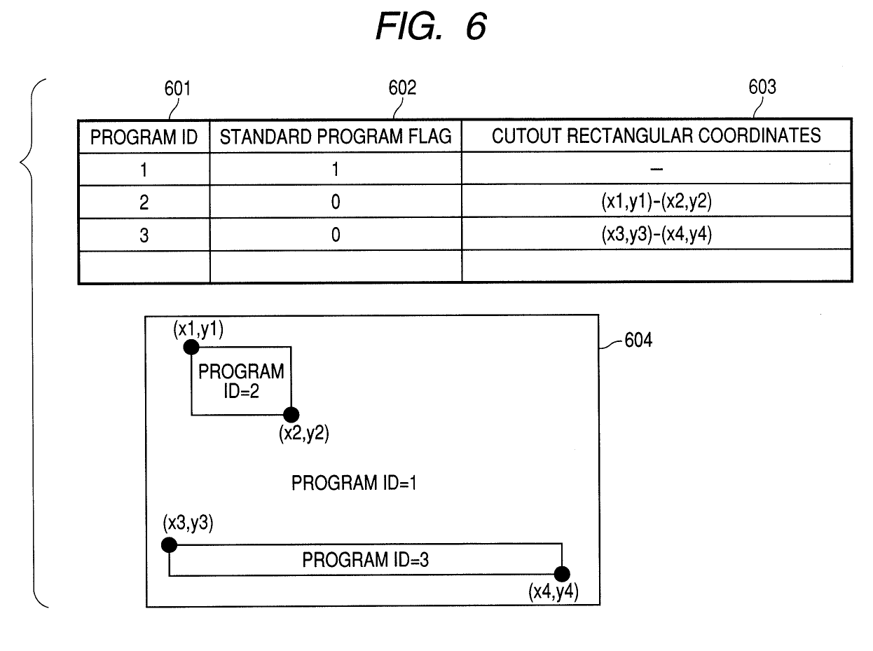

FIG. 6 shows information and a sample screen stored in the memory part 106 in the method of selecting part of a program screen by dragging a pointer described in FIG. 5. In the diagram, a program ID 601 for each program, a main program flag 602 which shows whether or not this is a main program, and coordinate information 603 of the part to be cut out, are retained. When the main program flag is 1, this program is the main program, and when the main program flag is 0, it is not the main program, and part of the screen can be freely cut out and displayed superimposed on the main program. In the diagram, since the program having the program ID=1 is set as the main program, a square area is not cut out. In the diagram, for programs having the ID=2 and ID=3, coordinate information (x1, y1), (x2, y2), (x3, y3), and (x4, y4) is acquired by dragging the pointer, and saved in the storage unit. In the diagram, as an example of an actual screen, a square area specified by the aforesaid coordinates in the program ID 2 or 3 which are not main programs, is displayed superimposed on the program having ID=1 which is the main program as shown by 604.

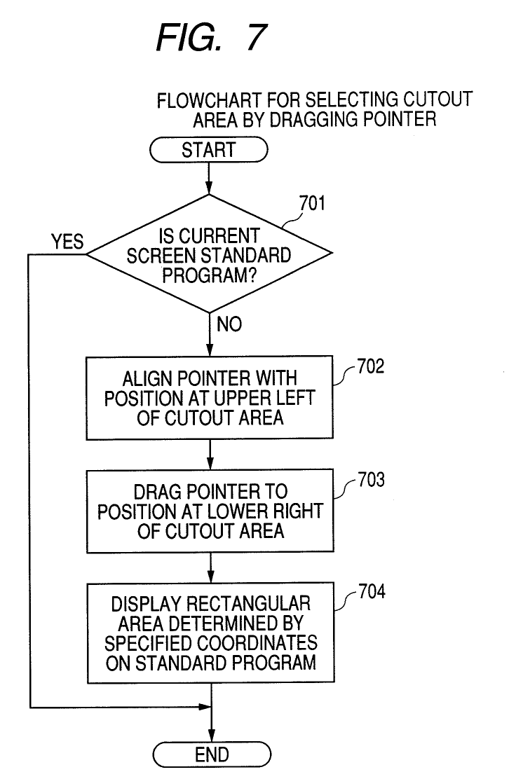

FIG. 7 is a flow chart showing the sequence of operations when a square area is cut out by dragging the pointer as described in FIG. 5 and FIG. 6. In the diagram, first, it is determined whether or not the selected program is the main program (701). If it is the main program, processing which displays part of the screen is not performed. In the diagram, if the selected program is not the main program, the coordinates of the cutout area in the screen of the program are acquired. For example, when cutting out a square area, if the upper left coordinates of the square area are acquired (702) and then the lower right coordinates are acquired (703), the cutout square is determined by these two coordinates. In the diagram, after acquiring the coordinates of the cutout square, a determination step is performed, and the cutout area is displayed superimposed on the main program (704).

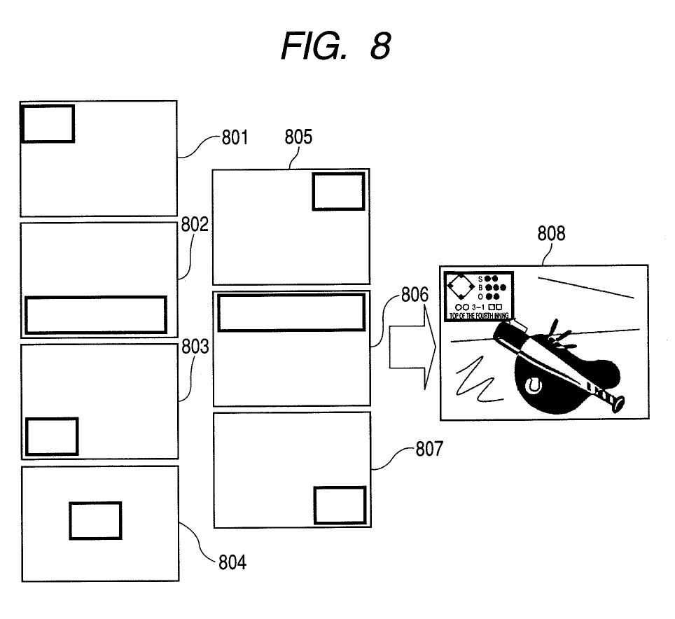

FIG. 8 shows another example of a way the user can cut out part of the screen in the invention. In this example, the user can select a pattern from among several predefined cutout patterns, and cut out a part which coincides with this pattern.

In the diagram, 801, 802, 803, 804, 805, 806, 807 are respectively a pattern for cutting out the upper left of the screen, a pattern for cutting out the lower part of the screen, a pattern for cutting out the lower left part of the screen, a pattern for cutting out the center part of the screen, a pattern for cutting out the upper right of the screen, a pattern for cutting out the upper part of the screen, and a pattern for cutting out the lower right of the screen.

In the diagram, the user can cut out the corresponding part in the screen simply by selecting this cutout pattern. In this example, a case is shown where a cutout pattern to cut out the upper left of the screen is selected, and the match points of a baseball program are cut out (808).

In this example, after cutting out the selected cutout pattern, the cutout area may if required also be fine-tuned. For example, the cutout area may be enlarged or reduced by dragging the boundaries of the cutout area with the pointer, or shifting the position of the upper side, lower side, right side and left side using the upper, lower, left and right buttons of the remote controller.

Although an example using seven patterns was shown in the diagram, the number of patterns may be larger or smaller than this.

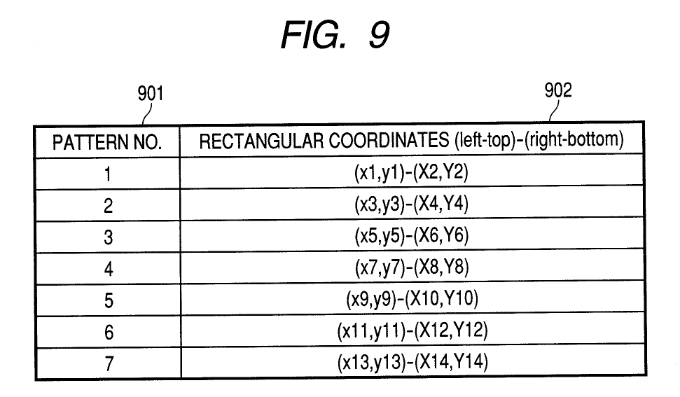

FIG. 9 shows an example of the information in the cutout patterns described in FIG. 8. In the diagram, a pattern number 901 and coordinates 902 of the cutout area of each cutout pattern are stored in the storage unit 106.

The computing unit 105 reads the coordinates of the cutout area which are retained in the selected pattern, cuts out an area corresponding to these coordinates from the program screen, and displays it superimposed on the main program.

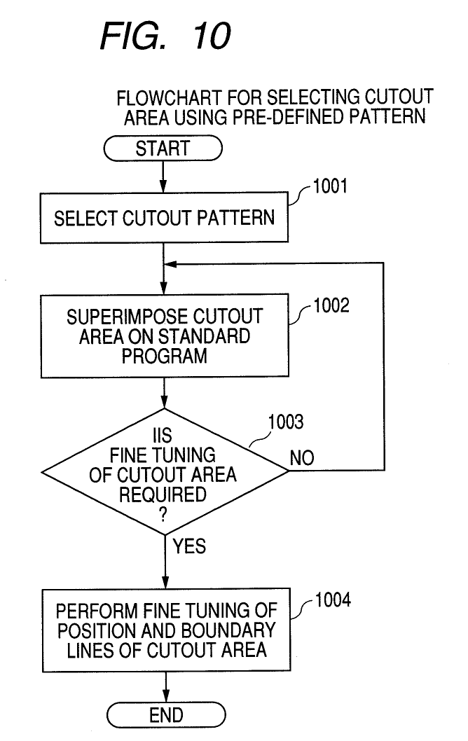

FIG. 10 is a flow chart showing the operating method for cutting out part of the screen using the patterns described in FIG. 8 and FIG. 9. In the diagram, first, one pattern is selected from among several pre-registered cutout patterns (1001).

Next, an area corresponding to the coordinates of the aforesaid selection pattern is displayed superimposed on the main program (1002). It is also determined whether or not fine-tuning such as the position and size of the superimposed area is required (1003), and if it is required, the cutout area is fine-tuned and redisplayed by dragging the mouse pointer or shifting the upper, lower, left and right sides (1004).

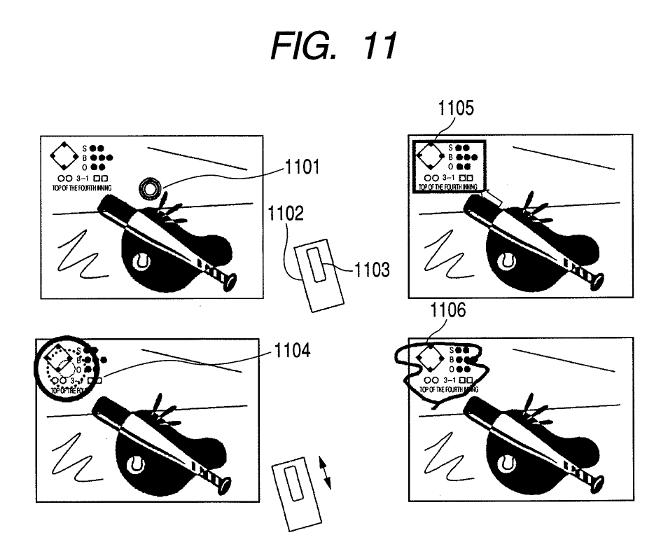

FIG. 11 shows an example where part of the screen is cut out using a free pointer. In this example, when a specific button of a remote controller 1102 is pushed, a pointer 1101 appears on the screen. The remote controller has a gyroscope sensor or a sensor for detecting orientation such as an acceleration sensor, and the user can move the pointer to any desired location on the screen by directional operation of the remote controller.

In the diagram, after moving the pointer close to the area it is desired to cut out, the user can change the size of the pointer for example by means of a wheel 1103 or a magnification/demagnification button with which the remote controller is provided, and the desired area can thereby be enclosed (1102).

In the diagram, after the motion of the pointer has stopped and the change in the size of the pointer has stopped, when a predetermined time has elapsed, the predetermined area can be cut out by a square 1105 or any desired outline 1106.

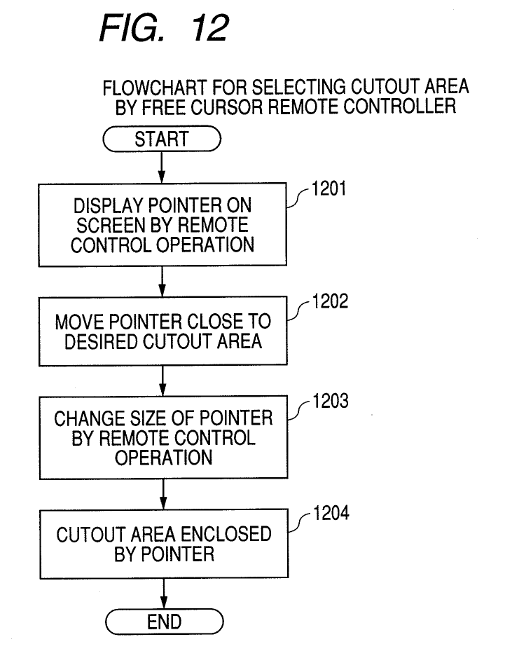

FIG. 12 is a flow chart showing the processing in the method shown in FIG. 11. In the diagram, first, when a predetermined button on the remote control is pressed, a pointer is displayed on the screen (1201). Next, the pointer is moved close to the area it is desired to cut out (1202), this area is selected (1203), and the selected area is displayed superimposed on the main program (1204).

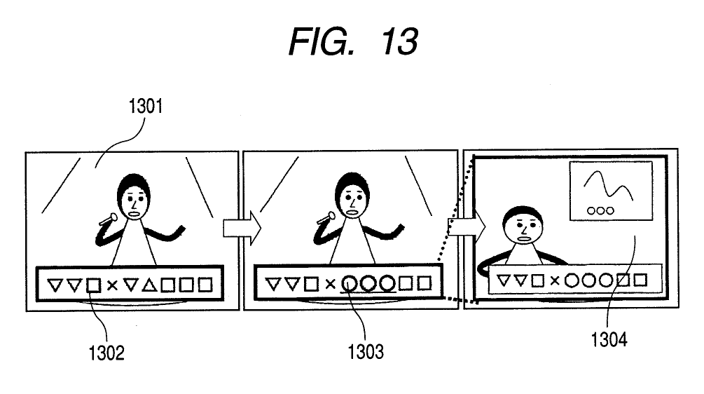

FIG. 13 shows one example of a method for changing the size of the cutout screen. In this example, when the system detects a keyword which is pre-registered by the user, the screen of a channel broadcasting content related to this keyword is enlarged.

In the diagram, a telop 1302 of a news program is displayed superimposed on a music program 1301.

In the diagram, suppose that the user has pre-registered the keyword “OOO” which occurs in the news program.

In the diagram, a means of recognizing text information contained in the broadcast image by image recognition, is installed in the television or PC for viewing the program.

In the diagram, when the keyword “OOO” which the user defined beforehand is displayed in the telop of the news program, “OOO” which is contained in the telop of the image is recognized by an image recognition technique (1303).

In the diagram, after the system recognizes the pre-registered keyword “OOO”, the screen of the news program is automatically enlarged (1304). It is then possible, during the music program, to view only news related to the keyword “OOO” on an enlarged screen while other news topics are displayed only as telop information, while still mainly viewing the music program.

In the diagram, apart from detecting the key word “OOO” by extracting words contained in the telop using the aforesaid image recognition technique, an utterance of an announcer in the news program may be detected using a speech recognition technique, and the keyword “OOO” in the utterance detected by word spotting. In this case, the system performs successive extraction of an audio amount, and compares it with the audio amount of the pre-registered keyword “OOO”. If the audio amount of the keyword “OOO”, and an audio amount which is successively calculated and extracted, coincide, the keyword “OOO” is detected.

Alternatively, detection may be performed based on text information contained in a digital broadcast.

In the diagram, if the news program 1302 is displayed enlarged due to detection of a keyword (1304), the music program 1301 will be hidden. For this reason, when the news program 1304 returns to its original size, i.e., only a partial display (1302), the images in the music program 1301 must be read from the time they were hidden by the news program 1304.

Here, the images in the music program 1301 start to be recorded in the storage unit from the moment when the news program 1302 is displayed enlarged due to detection of the keyword. When the news program 1304 returns to its original size 1302, reading of the image data of the music program 1301 recorded in the storage unit, starts. This reading may be performed at the present time for example by performing “fast forward”, or by reading only exciting scenes. Hence, the user can view the program without missing any details of the music program 1301.

Here, an example was shown where the cutout screen was enlarged, but the invention is not limited to enlargement, and any method which captures the attention of the viewer such as flashing, sound or other display may be used.

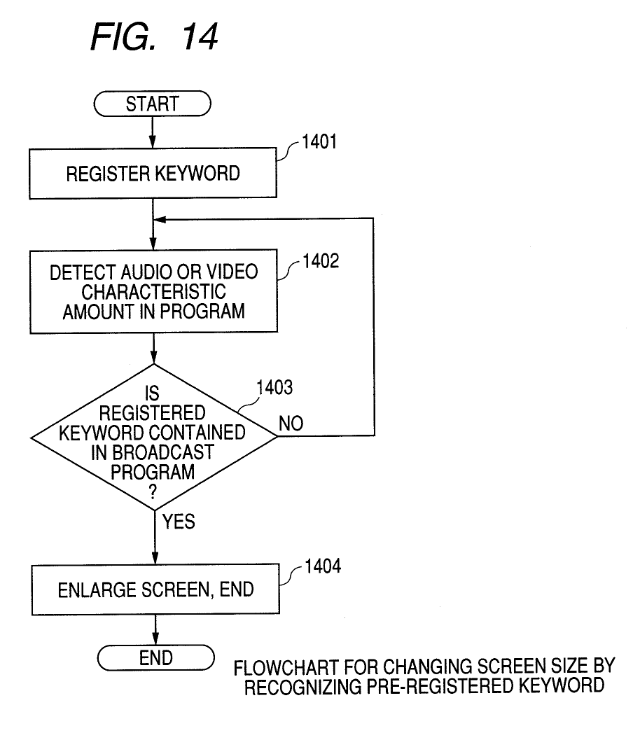

FIG. 14 is a flow chart showing the processing of FIG. 13. In the diagram, first, a keyword to be detected is registered (1401). The system continually extracts a program video or audio amount using character recognition, image recognition or speech recognition (1402). It is determined whether or not the extracted video or audio amount coincides with the video or audio amount of the pre-registered keyword (1403). If they do coincide, the program containing the keyword is shown enlarged.

By the method shown in FIG. 13 and FIG. 14, to read the information which matches the pre-registered keyword, the user can display the program screen enlarged, and can view the program without missing a scene he wants to see.

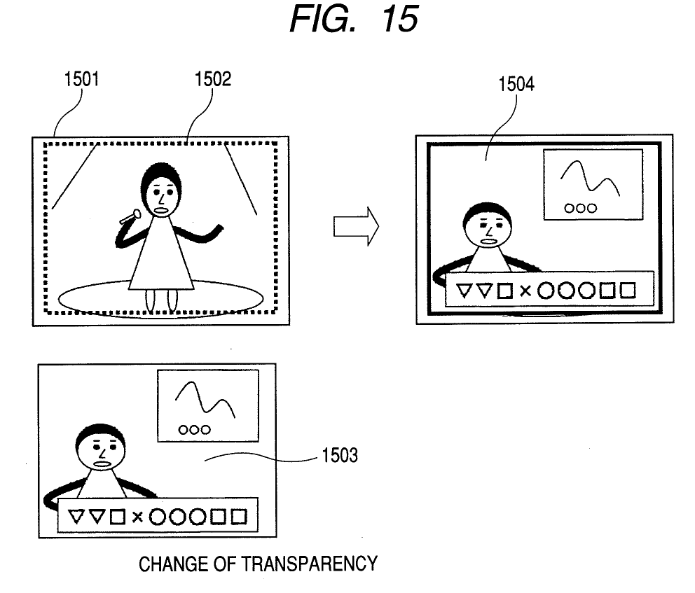

FIG. 15 shows another example of the method of the invention wherein the user can acquire also news program information while mainly viewing a music program. In this example, part or whole of the screen of a news program 1504 is displayed superimposed on the screen of a music program 1501 with a transparency 0 (i.e., invisible) (1502). Hence, only the music program can be viewed without viewing the news program. In the diagram, as in the example of FIG. 13, if a keyword for the news program which has been pre-registered by the user is detected, the transparency of the news program display is changed from 0 to 100, and as a result, part or all of the news program superimposed on the music program becomes visible, and can be viewed (1504).

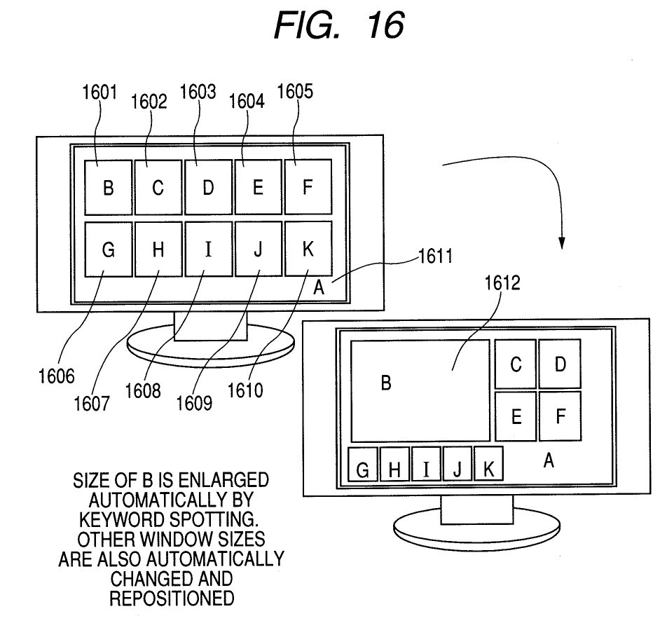

FIG. 16 is a diagram showing another example of how to superimpose a cutout image according to the invention. In the diagram, suppose that parts B-K of a screen cutout from each of 10 programs are displayed on a main program A1611 (1601-1610) In the diagram, if the screen size cut out from for example program B is enlarged as described in FIG. 13, the optimum size and position of the screens for the remaining 9 programs are calculated according to the position and size of the enlarged window, and repositioning is automatically performed so that all of the 10 programs are displayed (1612).

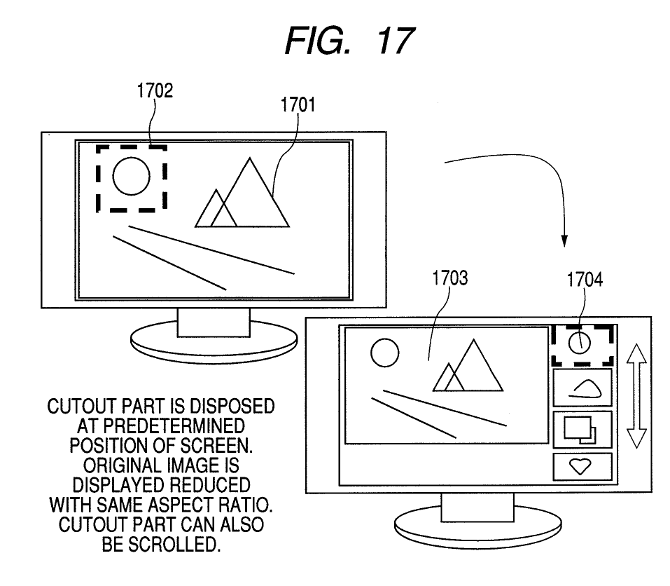

FIG. 17 is a diagram showing another example of how to superimpose the cutout image in the invention. In the diagram, a method is shown where the cutout screen is not superimposed on a program, but is disposed alongside one area of the screen (in this example, the right-hand end). In the diagram, whenever a screen is cut out, the screens 1702 are disposed one after another in a predetermined area 1704 of the TV screen. In the diagram, a screen situated in the predetermined area can be displayed sequentially for example by scrolling, and the user can select any desired cutout images. Also in the diagram, if a cutout image is disposed in the predetermined area, an original image 1701 is reduced while maintaining the aspect ratio so that it fits onto the screen (1703).

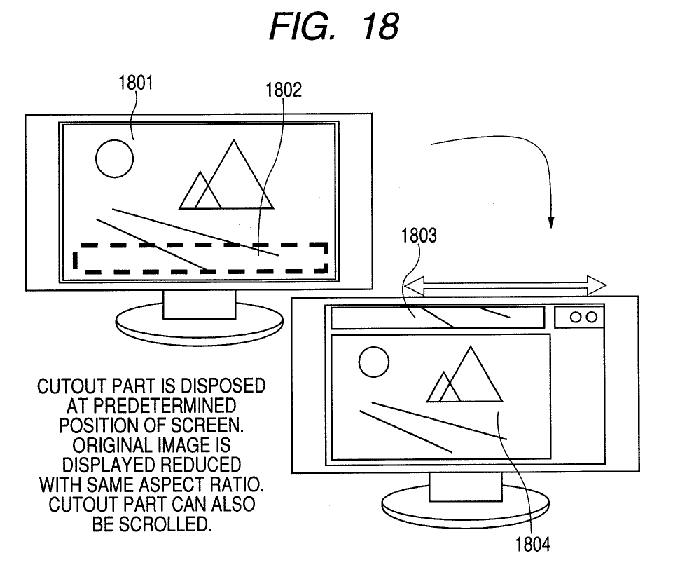

FIG. 18 shows an example of a method where the cutout image is not superimposed as in FIG. 17, and in this case, suppose that the cutout image is a rectangular area. In the diagram, when the cutout area is for example, a screen area 1802, as in the case of FIG. 17, an original image 1801 is redisplayed reduced while maintaining the aspect ratio (1804). In the diagram, instead of an image 1803 situated in a specific upper area, another image can be displayed for example by horizontal scrolling, so the user can select a desired image.

So far, a method was described where the broadcast signal was processed by an application (a signal processing technique such as speech recognition or image recognition) on the client terminal of the user, and a cutout screen was displayed superimposed on the original screen. There is also a method where information for performing a cutout is embedded in the broadcast signal transmitted from the broadcast side. Hereafter, this method will be described referring to examples.

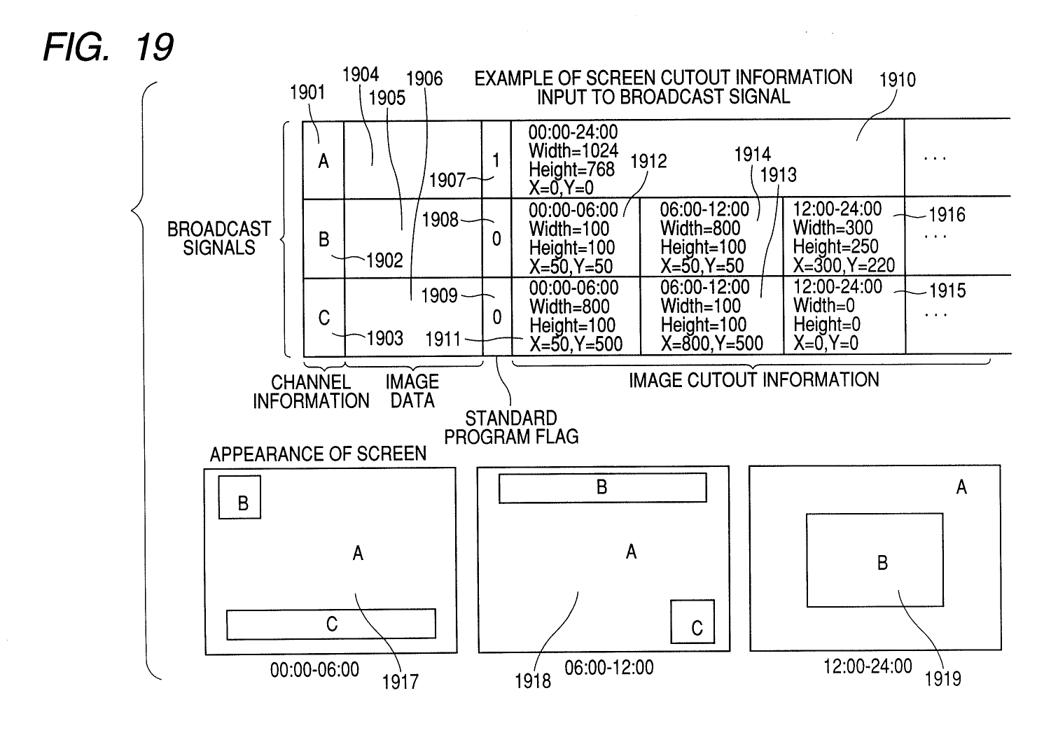

FIG. 19 shows an example where information for cutting out a screen is contained in the broadcast signal. In the diagram, suppose that three programs are simultaneously distributed from a broadcasting station. In the diagram, the broadcast signal comprises channel information 1901, 1902, 1903, image data 1904, 1905, 1906, main program flags 1907, 1908, 1909, and various information 1910-1916 for screen cutout. In the diagram, the channel information denotes a channel name, program or ID, and in this example, names A1901, B1902, C1903 are assigned to each channel.

In the diagram, the image data 1904, 1905, 1906 are actually image content data. In the diagram, a main program flag shows whether the program is the main program. If the main program flag is 1, the program is the main program, and if it is 0, it is not the main program. In the diagram, the various information for screen cutout are time information, width, height and coordinates of the origin of the cutout area. However, this is only an example, and other information may be input to perform screen cutout.

Describing this for the cutout information 1910 of channel A in the figure, a cutout is displayed from 0:00-24:00 at the origin (0, 0) with a width of 1024 pixels and height of 768 pixels. Likewise, for cutout information 1912, 1914, 1916 of channel B in the diagram, a cutout is displayed from 0:00-6:00 at the origin (50, 50) with a width of 800 pixels and height of 100 pixels, and from 12:00 to 24:00, a cutout is displayed from 0:00-6:00 at the origin (300, 220) with a width of 300 pixels and height of 250 pixels. Likewise, for cutout information 1911, 1913, 1915 of channel C in the diagram, a cutout is displayed from 0:00-6:00 at the origin (50, 500) with a width of 800 pixels and height of 100 pixels, a cutout is displayed from 6:00-12:00 at the origin (800, 500) with a width of 100 pixels and height of 100 pixels, and a cutout is displayed from 12:00-24:00 at the origin (0, 0) with a width of 0 pixels and height of 0 pixels. As a result, the appearance of the screen actually displayed changes with elapsed time, as shown in this diagram.

In these diagrams 1917, 1918, 1919 show actual examples of the display of these three programs, and since the main program flag 1907 of channel A is 1, parts of the channels B and C are displayed superimposed on channel A. In the diagram, from 00:00 to 06:00, the display is as shown in FIG. 1917 according to the cutout information of each channel. In the diagram, from 06:00 to 12:00, the display is as shown in FIG. 1918 according to the cutout information of each channel. In the diagram, from 12:00 to 24:00, the display is as shown in FIG. 1919 according to the cutout information of each channel. In this example, since channel C is at the origin (0, 0) with a width of 0 pixels and height of 0 pixels, it is not displayed.

By receiving the broadcast signal shown in the diagram, the user can display the cutout screen superimposed by a simple operation, for example by switching a “cutout” switch to ON or OFF on a remote controller or the like, without having to perform the cutout operation on the screen himself.

In the description of this diagram, the case was shown where information related to the time, screen size and screen position was contained in the broadcast signal, but other information may be contained such as for example the transparency of the image, or links to information on the Internet related to objects contained in the image. Other examples of information which may be contained in the broadcast signal are the position or length of a telop contained in the broadcast program, or information about a person's position. Due to this, the telop part or human part may be cut out without having to recognize the image on the client side.

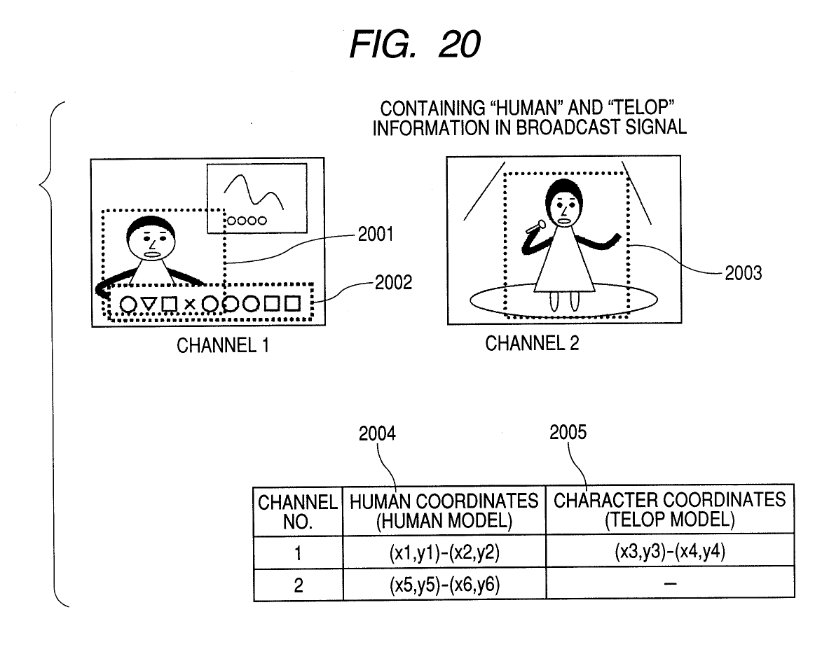

FIG. 20 shows an example where the broadcast signal contains information about a person's position in the image or the position of text information (telop). In the diagram, suppose the broadcast signal contains an information table containing coordinates 2004 showing the person's position, and coordinates 2005 showing the telop's position. Suppose this table contains information such as coordinates 2001 showing a person's coordinates and a telop position 2002 on Channel 1, and a person's position 2003 on Channel 2. The user can, for example by enabling a screen cutout function, cut out only the human or telop part and display it superimposed on the main program. In the diagram, time information was not described, but as in the case of FIG. 19, this table may contain also time information, i.e., from what time until what time and at what position a person is displayed.

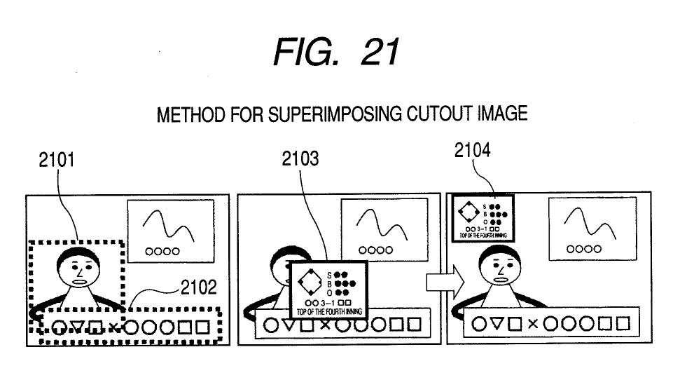

FIG. 21 shows an example where the cutout screen is displayed superimposed on another program. In the diagram, a position 2101 of a “man” on the screen and a position 2102 of a “character” contained in the broadcast signal, are saved in the storage unit. Alternatively, this information may be contained in the broadcast signal, and extracted by an image recognition technique. The position of a “person”, the position of a “character”, and a position 2103 of a cutout rectangle it is desired to place on the screen, are compared by the computing unit, and if they overlap, they are moved to positions where they do not overlap.

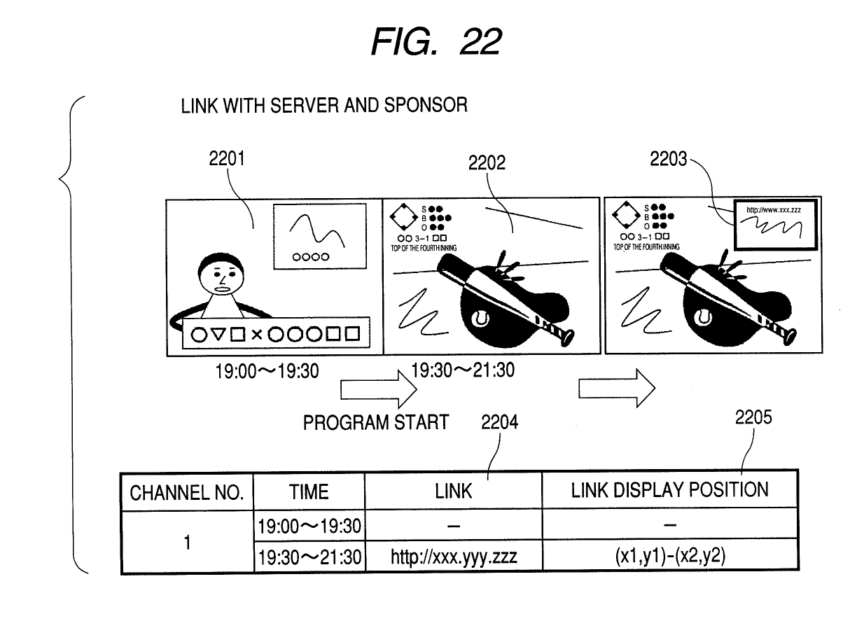

FIG. 22 describes a method relating to information access linked to objects in the image. In the diagram, suppose that, for example, a baseball broadcast started at 19:30 (2202). At this time, by containing links about the program sponsor's Internet site in the broadcast signal, the Internet site of a baseball equipment maker who is the program sponsor, can be displayed superimposed on another screen simultaneously when the baseball broadcast program starts (2203). In the diagram, an information table as shown in this diagram is contained in the broadcast signal. In this example, since there is no link information from 19:00 to 19:30, the usual program screen is displayed (2201). In the diagram, from 19:30 to 21:30, a link 2204 and information 2205 about the link display position are distributed with the broadcast signal, so for example, the sponsor's website is displayed at the coordinates of the link display position on the screen.

In the diagram, an example was described where the broadcast signal contained link information, but as an example where link information is not contained in the broadcast signal, an object contained in the broadcast image may be recognized by image recognition on the client side, the Internet site related to this object accessed, and this screen displayed superimposed thereupon. In this example, image recognition is performed for example on baseball equipment such as the bat which a baseball player is using during the baseball program, the Internet site of the baseball equipment maker is accessed, and that screen is displayed superimposed thereupon.

As described so far, according to the invention, information is efficiently displayed by cutting out the essential parts from plural broadcast signals.

An example was described where, in order to contain the time, position and size of cutout parts, and link information in the broadcast signal, an information table was constructed, and was distributed together with the image data. A method was described where the user cut out a desired area himself, but in this case also, an identical information table can be saved in the storage unit as history (log). A typical application of such an information table required for screen cutout, will now be described.

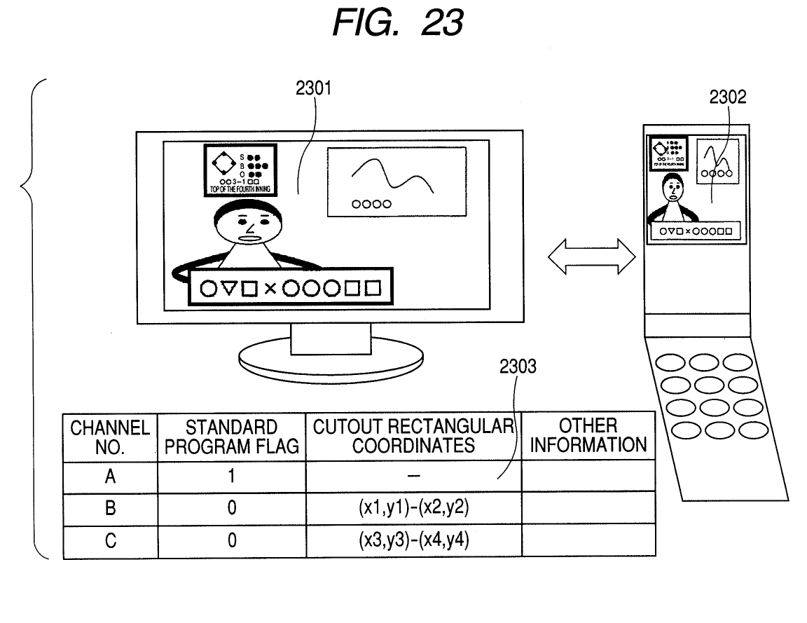

FIG. 23 shows an example where the user sends a screen cutout and superimposition information to another user terminal or another information terminal using, for example, e-mail or the like. In the diagram, first, the user, while viewing program A on TV, views a part of program B and a part of program C displayed superimposed on the screen of program A (2301). In the diagram, an information table 2303 for screen cutout is saved in the storage unit. This information table 2303 may be contained in the broadcast signal, or the user may generate it from his own cutout history.

In the diagram, the user, in order to reproduce the screen layout such as the names of the channels broadcasting programs A, B, C, the size of part of channel B, the size of part of channel C, one coordinate of the part of channel B superimposed on channel A, one coordinate of the part of channel C superimposed on channel A, the required information 2303 can be transmitted to the other information display device by a communications device such as e-mail or the like. Due to this, for example, the programs A, B, C can be viewed on the screen of a mobile phone with exactly the same screen layout as the screen viewed on TV (2302).

The information for reproducing the screen layout in this diagram, in addition to the screen size and position information, includes the transmittancy of the screen, the screen cutout start and end time (from when and to when, about how large it was and in which position it was superimposed), and link information. In the above diagram, when a screen of the 3 programs A, B, C which are displayed superimposed on one another are recorded, information for reading the aforesaid screen is simultaneously saved, and when it is later read, the recorded program can be viewed with the same screen layout as when it was viewed live.

The user's cutout history and information table 2303 may also be sent to a broadcasting company or content management operator to collect data as to what part and to what extent a broadcast screen was cut out and viewed.

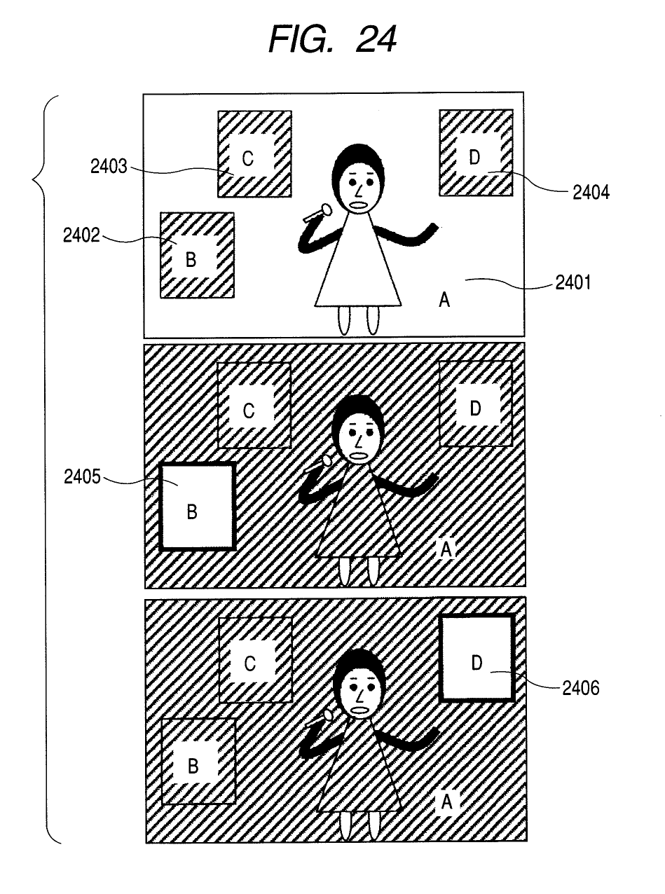

FIG. 24 shows another example wherein a part of plural channels is cut out and displayed superimposed on one other. So far, the case was described where a part of plural channels was cut out, and this part was displayed superimposed in its original form of a moving image. In the example shown in FIG. 24, the situation is shown where a still image of a screen obtained by cutting out part of a channel is displayed superimposed on another channel. In the diagram, a program A2401 is displayed as a moving image, and parts of programs B2402, C2403, D2404 are cut out and displayed superimposed on program A as still images. In the diagram, the user can highlight the focus on a still image by operating devices such as for example a remote controller 2405. In the diagram, when the focus is highlighted on the still image, the moving image is read from the time when the still image was captured.

In the diagram, the focused still image can be read in real-time, or it can be read by digest reading using the audio amount or video amount. In the diagram, when the focus is moved to another still image, the screen which was highlighted before the focus was moved is displayed as the still image when the moving image was read, and the newly highlighted still image starts to be read as a moving image (2406).

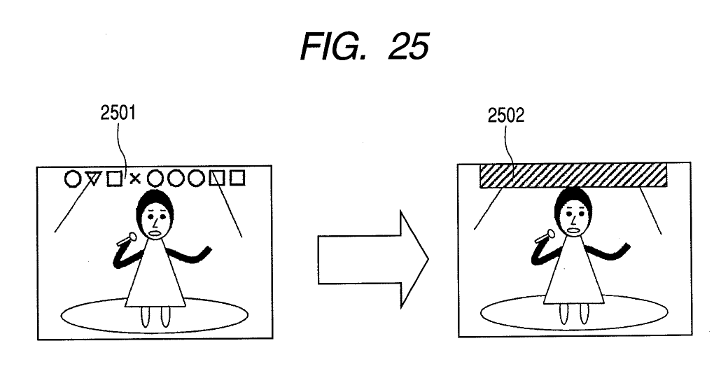

FIG. 25 shows an example where, in the invention, a specified area of the screen is hidden by another screen. In the example shown in the diagram, a telop 2501 showing for example an emergency newsflash is inserted in the upper part of the screen of a recorded music program. If such a telop is displayed for example on the scene of a favorite singer appearing in the music program, the user cannot view the program in comfort. Hence, in the invention, by superimposing another screen (2502) on the area where the telop is displayed, information which is annoying to the user can be eliminated from the screen. In the diagram, the screen 2502 which is superimposed may be another screen area, may be a simple rectangle, or may be an image processing effect such as a mosaic or other such means.

In the diagram, apart from the method where another screen is superimposed on the area which it is desired to eliminate such as a newsflash, this area can be detected by image recognition, and the colors of the pixels can be homogenized. In the diagram, as another example of information it is desired to eliminate, apart from the aforesaid text information, there may be scenes which are undesirable for viewing by children.

In the aforesaid figure, when a scene it is designed to eliminate is detected by image recognition or the like, in addition to eliminating this part by superimposing a cutout image, processing can also be performed to eliminate the sound of this part.

What is claimed is:

1. An information reading apparatus, comprising:
receiving means which receives first and second broadcast signals;
information reading means which displays and reads said first broadcast signal received by said receiving means as first image information;
storage means which stores the second image information contained in said second broadcast signal; and
extraction means which extracts a part of the second image information stored by said storage means,
wherein said information display means displays a part of the image in said second image information extracted by said extraction means superimposed on the image of said first image information, and reads it.

2. The information reading apparatus according to claim 1, further comprising:
input means which inputs information from the outside,
wherein said extraction means extracts a part of said second image information selected by said input means.

3. The information reading apparatus according to claim 1, wherein, when an audio signal in said second broadcast signal is equal to or exceeds a predetermined value, or when said audio signal includes predetermined waveform information or approximates it with predetermined waveform information, or when a variation of said audio signal exceeds a predetermined value, said extraction means displays a part of said second image information superimposed on said first image information, and reads it.

4. The information reading apparatus according to claim 1, wherein said extraction means extracts a part of said second image information by performing image recognition of predetermined image information from said second image information.

5. The information reading apparatus according to claim 1,
wherein, when said second broadcast signal contains a predetermined character array, said text information is displayed superimposed on said first image information, and read.

6. The information reading apparatus according to claim 1, comprising input means which inputs information from the outside,
wherein said first broadcast signal or said second broadcast signal is selected as a main program based on the specification of said input means and displayed on the full screen of said information display means, and part of one thereof is extracted and displayed superimposed on the other.

7. The information reading apparatus according to claim 1, comprising:
input means which inputs information from the outside,
wherein, when information included in said second broadcast signal contains information inputted from said input means, an alarm is output.

8. The information reading apparatus according to claim 7,
wherein, when information included in said second broadcast signal contains information inputted from said input means, the size of the image in said second image information is expanded.

9. The information reading apparatus according to claim 7,
wherein, when information included in said second broadcast signal contains information inputted from said input means, the image in said second image information is displayed with variable transparency.

10. An information reading apparatus, comprising:
receiving means which receives first and second broadcast signals; and
information reading means which displays and reads said first broadcast signal received by said receiving means as first image information,
wherein said second broadcast signal has second image information and position information in the whole of the display area of said information reading means of said second image information,
wherein said apparatus comprises storage means which stores said second image information and said position information, and
wherein said information display means displays an image in said second image information at a position in the whole of the display area of said position information stored by said storage means superimposed on an image in said first image information.

11. The information reading apparatus according to claim 9,
wherein said second broadcast signal contains text information.

12. The information reading apparatus according to claim 9,
wherein said second broadcast signal has time information, and said information display means superimposes and displays the image in said second image information at a position in the whole display area of said position information on the image in said first image information based on said time information.

13. The information reading apparatus according to claim 9,
wherein said second broadcast signal has information or text information about a person's position.

14. The information reading apparatus according to claim 9,
wherein said second broadcast signal contains a link to an address on the Internet about information contained in said second image information.

15. The information reading apparatus according to claim 1,
wherein said information display means displays said second image information as a static image, and said information display means reads said second image information as a moving image based on the input from said input means.
